(19) United States
(12) Patent Application Publication
(10) Pub. No.: US 2015/0001255 A1
(43) Pub. Date: Jan. 1, 2015

(54) WATER SUPPLY APPARATUS FOR WATER SPRAY CONTAINER

(71) Applicant: CHUANG WEI, TAIPEI CITY (TW)

(72) Inventor: CHUANG WEI, TAIPEI CITY (TW)

(21) Appl. No.: 13/928,574

(22) Filed: Jun. 27, 2013

(51) Int. Cl. B67D 7/58; B67D 7/78

(52) U.S. Cl. CPC B05B 11/0037
USPC 222/382; 222/464.1

(57) ABSTRACT

A water supply apparatus for a water spray container comprises a container and a water absorber. The container comprises a spray nozzle, a pressure handle provided at a front of the spray nozzle and a suction tube connected to a bottom of the spray nozzle. The water absorber is of an elongated column shape comprising an axial cutting slot at an axial central end to allow the suction tube of the spray nozzle to insert into the cutting slot such that the water absorber encloses an outer of the suction inlet of the suction tube. With the absorption of the water absorber, the suction inlet of the suction tube is kept at a saturation state such that when the container is placed upside down or tilted, the liquid can be sprayed out successfully via pressing the pressure handle and the spraying of the water spray container is convenient and effective.

### BACKGROUND OF THE INVENTION

1. Technical Field

The present invention is related to a water supply apparatus for a water spray container, which can be used to allow a suction inlet of a suction tube inside the water spray container to be maintained at a water saturation state such that when the container is placed upside down or at any tilting angle, the liquid can be sprayed out successfully via pressing a pressure handle thereof and such that the spraying operation of the water spray container is more convenient and more effective as merits and scopes of the improved water spray container.

2. Description of Related Art

Water spray containers capable of spraying out the liquid contained inside the container by ways of water spraying jets or moistures are widely used for such as perfume bottles, various types of cosmetic containers, gardening water sprays and sculpture water sprays. As the liquids contained inside the containers are being protected from the hands of users, they can also be used as spraying containers for various chemical components such as dirt removal agents, lubricants and hygiene cleaning liquids.

Traditionally water spray containers are typically of the structure including a container opening end installed with a spray nozzle having a small piston pump arranged therein, which also includes a pressure handle installed on the spray nozzle, a suction tube connected to the bottom of the spray nozzle, and the suction tube extends inside the container to absorb the liquid therein. Depending upon the type of the liquid, the container can be made of different materials and various shapes; in addition, the pressure handle can also be made of different structures such as finger-pressing type, pressure pressing type or pulling handle type.

During the actual operations of the aforementioned traditional water spray containers and if the container is placed in an upright vertical position, the water absorbing end of the suction tube can be maintained in contact with the liquid and the user is able to eject the water spray successfully by pressing down the pressure handle on the spray nozzle to allow the small piston pump to work properly. However, in another situation where due to the needs of operation, the container needs to be tilted or placed upside down in a reverse direction, then the water absorbing end of the suction tube would extend over the top of the liquid surface, during which the pressing of the pressure handle would only suck the air into the suction tube without successfully absorbing the liquid, and the container needs to reversed to the upright position with a few more presses on the pressure handle to allow the suction tube to return to its proper water supplying. Therefore, such structure is inconvenient to the operation and usage thereof.

There are certain traditional water spray containers having the design of a metal ball added to the water absorbing end of the suction tube in order to use its weight to allow the water absorbing end to be maintained below the liquid surface and to be in contact with the liquid at all times such that the container can still work properly to spray out the liquid when being placed in either titling or upside down positions. However, a noticeable drawback to such type of water spray container is that when the container is being tilted or placed upside down, the supply of water is blocked due to the bending of the suction tube; in addition, the corner areas inside the container where the ball cannot be reached would still causes difficulties in absorbing the remaining liquid therein, which can be wasteful and troublesome to the practical uses thereof.

### SUMMARY OF THE INVENTION

To overcome the aforementioned drawbacks, the present invention provides an improved water supply apparatus for a water spray container.

In other words, a primary objective of the present invention is to provide a water supply apparatus for a water spray container, which can be used to allow a suction inlet of a suction tube inside the water spray container to be maintained at a water saturation state such that when the container is placed in a reverse direction or at any tilting angle, water can be sprayed out successfully via pressing a pressure handle thereof and such that the spraying operation of the water spray container is more convenient and more effective.

Another objective of the present invention is to provide a water supply apparatus for a water spray container capable of utilizing the liquid effectively without remains and wastes as improvements thereto.

To achieve the aforementioned objectives, the present invention utilizes the following means.

The water supply apparatus for a water spray container of the present invention comprises a container, a water absorber provided inside the container to form a structure thereof.

The container comprises a spray nozzle, a piston pump pre-installed inside the spray nozzle, a pressure handle provided at a frond end of the spray nozzle and a suction tube connected to a bottom portion of the spray nozzle.

The water absorber is generally of an elongated column shape and comprises an axial cutting slot at the axial central end to allow the suction tube at the bottom portion of the spray nozzle to insert into the cutting slot such that the water absorber encloses an outer portion of the suction inlet of the suction tube and such that the water supply device of the water spray container is formed.

Once the aforementioned water spray container is assembled completely, since the outer portion of the suction tube is enclosed by the water absorber and the suction inlet of the suction tube is inside the water absorber, regardless the amount of the liquid inside the container, the suction inlet of the suction tube can be kept at a water saturation state by using the water absorption and water retaining properties of the water absorber and such that when the container is either placed upside down in a reverse position or at any tiling angles, the liquid can still be successfully sprayed out via pressing on the pressure handle to prevent blockage of water supply under any circumstances and to achieve the objectives of the present invention.

### DESCRIPTION OF THE DRAWINGS

FIG. 1 is an illustration showing the outer appearance of an embodiment of the water spray container of the present invention.

FIG. 2 is an exploded view of the components of the present invention.

FIG. 3 is an enlarged view of the component of the water absorber of the present invention.

FIG. 4 is a cross sectional view of the components of the present invention.

FIG. 5 is an illustration showing the outer appearance of the second embodiment of the water spray container of the present invention.

### DESCRIPTION OF REFERENCE NUMERALS

10 container
11 opening end
12 spray nozzle
13 pressure handle
14 suction tube
15 water outlet
16 suction inlet
20 water absorber
21 cutting slot
30 container

### DETAILS OF EMBODIMENTS OF INVENTION

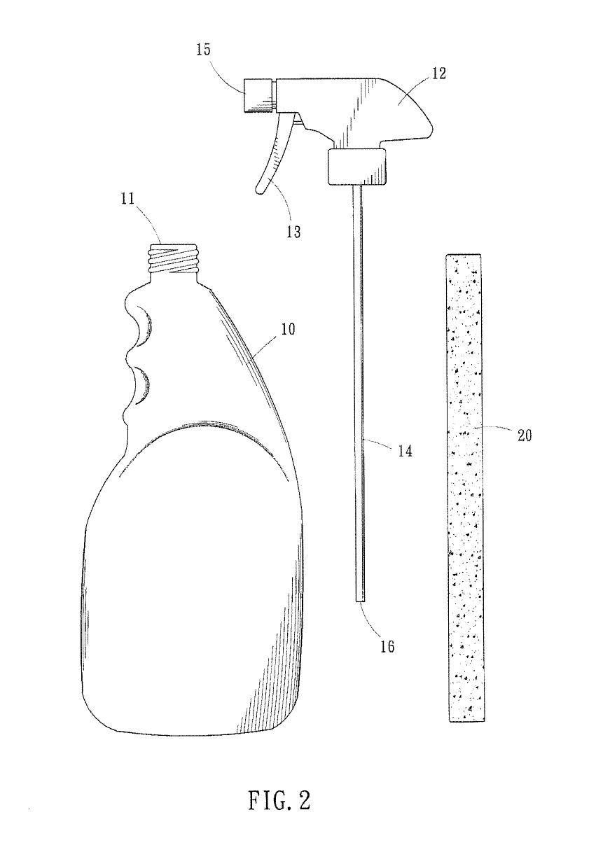

As shown in FIG. 2 enclosed, the water supply apparatus for a water spray container of the present invention comprises a container 10 and a water absorber 20 arranged inside the container to form the structure thereof.

As shown in FIG. 2, the container 10 comprises a spray nozzle 12 installed on an container opening end 11, a piston pump pre-installed inside the spray nozzle 12, a pressure handle 13 provided at a front end of the spray nozzle 12, a water outlet 15 with a rotatable adjuster provided at a top of the pressure handle 13 and a suction tube 14 connected to a bottom portion of the spray nozzle 12.

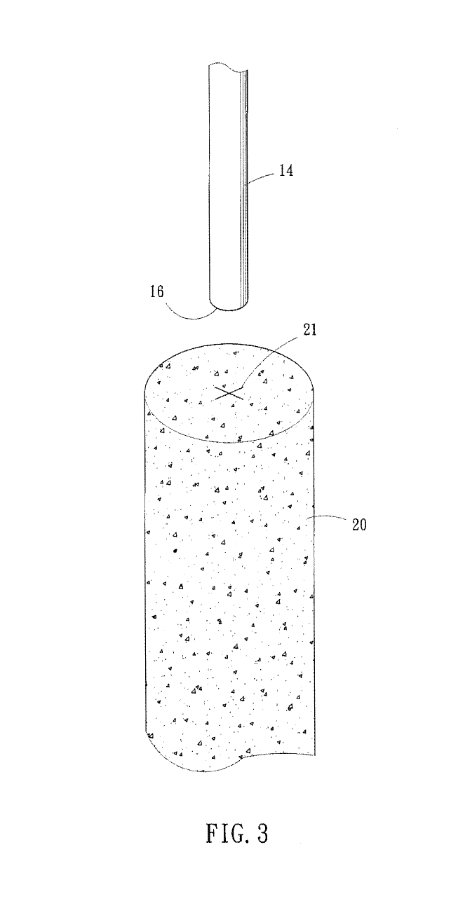

In addition, as shown in FIG. 2 and FIG. 3, the water absorber 20 is generally of an elongated column shape comprising an axial cutting slot 21 at an axial central end, and the cutting slot 21 allows the suction tube 14 at the bottom portion of the spray nozzle 12 to insert therein such that the water absorber 20 encloses an outer portion of a suction inlet 16 of the suction tube 14 to form the water supply apparatus of the water spray container.

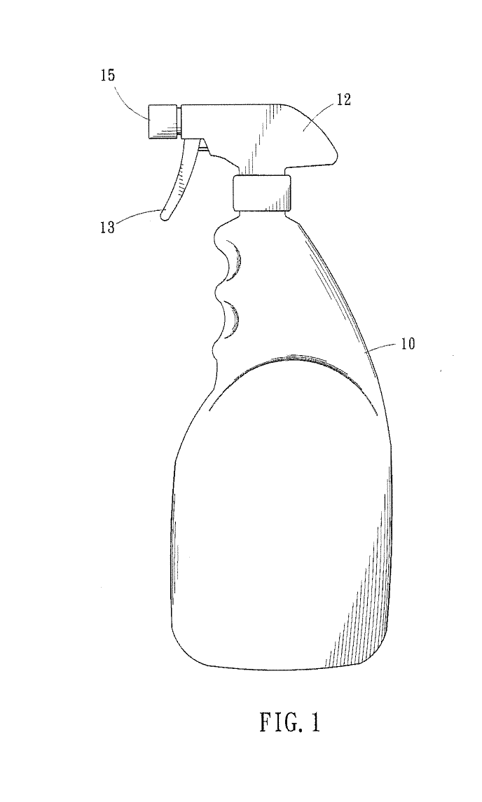

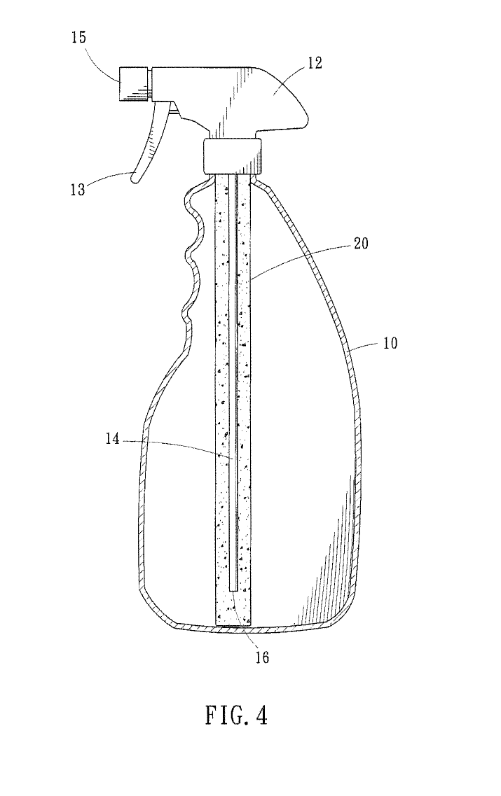

The completely assembled water spray container mentioned above is of the outer appearance as shown in FIG. 1, and FIG. 4 shows a cross sectional view thereof.

As shown in FIG. 4, since the outer portion of the suction tube 14 is enclosed by the water absorber 20 and the suction inlet 16 of the suction tube 14 is inside the water absorber 20, regardless the amount of the liquid inside the container 10, the suction inlet 16 of the suction tube 14 is kept to maintain at a water saturation state by using the water absorption and retaining properties of the water absorber 20 and such that when the container 10 is placed upside down or the container is tilted at any angles, the liquid can be sprayed out successfully via pressing the pressure handle 13 in order to prevent any water supply blockages under any circumstances.

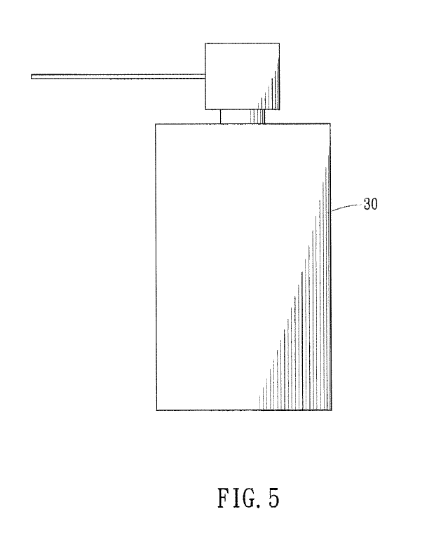

In an actual manufacturing process, the container 10 can be a type of container having a detachable spray nozzle 12 installed onto the opening end 11 as shown by the embodiment in FIG. 1 and FIG. 2. Alternatively, it can be a permanent spray nozzle such that the container is a disposable type of container as shown by the embodiment of container 30 in FIG. 5.

In an actual manufacturing process, the water absorber 20 can be any porous material with good water absorption such as a sponge or it can be a porous material made of wooden fiber fabrics or plastic foam polymers such as foam sponge.

In the embodiment shown in FIG. 2 and FIG. 4, the water absorber 20 is preferably to be of a circular column shape having a top end in contact with the opening end of the container and a lower end in contact with the bottom surface of the internal of the container 10; alternatively, the lower end of the water absorber 20 can be secured onto the bottom surface of the internal of the container 10 and the length of the suction tube 14 is shorter than the length of the water absorber 20.

1. A water supply apparatus for a water spray container, comprising:
a container comprising an opening end with a spray nozzle, a piston pump pre-installed inside the spray nozzle, a pressure handle provided at a front end of the spray nozzle, a water outlet with a rotatable adjuster provided on top of the pressure handle, a suction tube connected to a bottom portion of the spray nozzle; and
a water absorber in an elongated column shape and comprising an axial cutting slot at an axial central end; the cutting slot provided for the suction tube at the bottom portion of the spray nozzle to insert therein such that the water absorber encloses an outer portion of the suction inlet of the suction tube.

2. The water supply apparatus for a water spray container according to claim 1, wherein the container is a type of container having a detachable spray nozzle installed at the opening end thereof.

3. The water supply apparatus for a water spray container according to claim 1, wherein the container is a type of disposable container having a permanent spray nozzle.

4. The water supply apparatus for a water spray container according to claim 1, wherein the water absorber is a porous material with a good water absorption.

5. The water supply apparatus for a water spray container according to claim 1, wherein the water absorber is preferable to be of a circular column shape.

6. The water supply apparatus for a water spray container according to claim 1, wherein the water absorber having a top end in contact with the opening end of the container and a lower end in contact with a bottom surface of an internal of the container.

7. The water supply apparatus for a water spray container according to claim 1, wherein the water absorber having a top end in contact with the opening end of the container and a lower end secured onto a bottom surface of an internal of the container.
